(19) United States
(12) Patent Application Publication
(10) Pub. No.: US 2023/0185385 A1
(43) Pub. Date: Jun. 15, 2023

(54) MOBILE DEVICE INPUT DEVICE

(71) Applicant: Miguel Hernandez, Phoenix, AZ (US)

(72) Inventor: Miguel Hernandez, Phoenix, AZ (US)

(21) Appl. No.: 17/548,783

(22) Filed: Dec. 13, 2021

(51) Int. Cl. G06F 3/0346; G06F 3/01; G06F 3/03; G06F 3/16; G06F 3/02; A63B 24/00

(52) U.S. Cl. CPC G06F 3/0346; G06F 3/011; G06F 3/0304; G06F 3/16; G06F 3/02; A63B 24/0075

(57) ABSTRACT

A mobile device input device connected to a mobile device, the mobile device input device including a main body to be worn by a user, a control unit running a program thereon and disposed within at least a portion of the main body to at least one operation of the mobile device, and a laser sensor disposed on at least a portion of the main body to emit a laser beam away from a surface of the main body to track a position of the main body.

### BACKGROUND

### 1. Field

The present general inventive concept relates generally to an input device, and particularly, to a mobile device input device.

### 2. Description of the Related Art

Mobile devices, such as cell phones, tablets, and/or smart watches play an increasingly important role in a person's life today. Yet, many people become absorbed and/or distracted by a mobile device while performing daily tasks that require undivided attention, such as driving. Consequently, using the mobile device while driving poses serious threats to the person's safety and can result in a fatal accident.

Some people may receive messages and/or calls on the mobile device that cannot be delayed. For example, in an emergency situation where the person driving needs to respond immediately.

Therefore, there is a mobile device input device that facilitates use of the mobile device without having to divert the person's attention.

### SUMMARY

The present general inventive concept provides a mobile device input device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a mobile device input device connected to a mobile device, the mobile device input device including a main body to be worn by a user, a control unit running a program thereon and disposed within at least a portion of the main body to at least one operation of the mobile device, and a laser sensor disposed on at least a portion of the main body to emit a laser beam away from a surface of the main body to track a position of the main body.

The control unit may receive input to create an exercise training regimen.

The control unit may receive another input to create a timer for an exercise.

The control unit may send at least one command to the mobile device to move a cursor in response to moving the main body.

The control unit may determine movement of the main body that corresponds to other functions on the mobile device that are at least one of scrolling, zooming, clicking, tapping, sending a text, reading the text, and running an application.

The mobile device input device may further include an input button disposed on at least a portion of the main body to enter entry of information.

The mobile device input device may further include a speaker disposed on at least a portion of the main body to receive at least one sound input therein and emit at least one sound output therefrom.

The mobile device input device may further include a pad assembly removably connected to at least a portion of the main body to facilitate tracking of the laser sensor over the pad assembly in response to movement of the main body over the pad assembly.

The control unit may use GPS signaling to determine the position of the main body instead of the laser sensor while the main body is detached from the pad assembly.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a perspective view of a mobile device input device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Mobile Device Input Device 100
Main Body 110
Strap 111
Buckle 112
Control Unit 120
Display Unit 121
Processing Unit 122
Communication Unit 123
Storage Unit 124
Laser Sensor 130
Input Button 140
Volume Button 150
Speaker 160
Power Button 170
Power Source 180
Pad Assembly 190
Pad Body 191
Magnet 192
Communication Unit 193
Pad Power Source 194

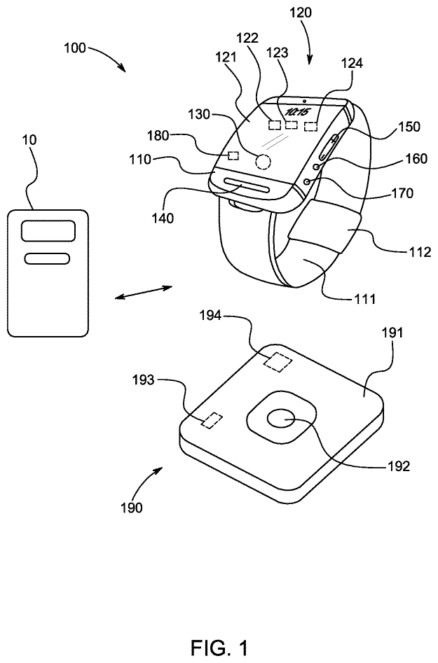

FIG. 1 illustrates a perspective view of a mobile device input device 100, according to an exemplary embodiment of the present general inventive concept.

The mobile device input device 100 may be constructed from at least one of metal, plastic, wood, glass, and rubber, etc., but is not limited thereto.

The mobile device input device 100 may include a main body 110, a control unit 120, a laser sensor 130, an input button 140, a volume button 150, a speaker 160, a power button 180, and a pad assembly 190, but is not limited thereto.

The main body 110 may also be referred to as a mouse, similar to a computer mouse. Moreover, the main body 110 may have a size to fit within at least a portion of a hand of a user.

The main body 110 may include a strap 111 and a buckle 112, but is not limited thereto.

The strap 111 may be removably connected to at least a portion of the main body 110. For example, the strap 111 may connect to at least a portion of the main body 110 via a groove on the main body 110 to slidably receive the strap 111 therein.

The buckle 112 may be disposed on at least a portion of a first end of the strap 111. Moreover, the buckle 112 may receive and/or connect to at least a portion of a second end of the strap 111. As such, the buckle 112 may adjust a length of the strap 111. More specifically, a length of the strap 111 may decrease in response to moving the strap 111 through the buckle 112 in a first direction, and increase in response to moving the strap 111 through the buckle 112 in a second direction opposite with respect to the first direction. Therefore, the strap 111 may facilitate wearing of the main body 110 by the user.

The control unit 120 may include a display unit 121, a processing unit 122, a communication unit 123, and a storage unit 124, but is not limited thereto.

The display unit 121 may include a plasma screen, an LCD screen, a light emitting diode (LED) screen, an organic LED (OLED) screen, a computer monitor, a hologram output unit, a sound outputting unit, or any other type of device that visually or aurally displays data. Also, the display unit 121 may be a touch-screen that receives an input thereon.

The processing unit 122 (or central processing unit, CPU) may include electronic circuitry to carry out instructions of a computer program by performing basic arithmetic, logical, control and input/output (I/O) operations specified by the instructions. The processing unit 122 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 122 may also include a microprocessor and a microcontroller.

The communication unit 123 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 124 may include a random access memory (RAM), a read-only memory (ROM), a hard disk, a flash drive, a database connected to the Internet, cloud-based storage, Internet-based storage, or any other type of storage unit.

The control unit 120 may be disposed within at least a portion of the main body 110 and access the Internet via the communication unit 123 to allow the user to access a website, and/or may allow a mobile application and/or a software application to be executed using the processing unit 122. For ease of description, the mobile and/or the software application will be hereinafter referred to as an app. The app may be downloaded from the Internet to be stored on the storage unit 124. Moreover, the app may be the same as and/or similar to the app stored on a mobile device 10. The display unit 121 may display various information, such as a time and/or a date.

The processing unit 122 executing the app may send at least one command via the communication unit 123 to control at least one operation of the mobile device 10.

The processing unit 122 executing the app may allow creation of an exercise training regimen. More specifically, the processing unit 122 may receive an input to create a timer (e.g., fifteen minutes, twenty minutes, forty-five minutes, sixty minutes, etc.) for an exercise (e.g., running, jump rope, lifting weights, cross fit, jumping, etc.). Moreover, the processing unit 122 executing the app may generate different exercise sets with any amount of rounds (e.g., one, two, five, ten, unlimited, etc.). It is important to note that the processing unit 122 executing the app may maintain the exercise training regimen while a screen of the mobile device 10 and/or the display unit 121 is locked. The processing unit 122 executing the app may allow creation of alternative exercise than those commonly known. In other words, the processing unit 122 executing the app may allow creation of new exercise though input of type of movements.

Additionally, the processing unit 122 executing the app may receive a save input to save the exercise training regimen and/or automatically save the exercise training regimen.

The laser sensor 130 may be disposed on and/or within at least a portion of the main body 110. The laser sensor 130 may emit a laser beam away from a surface of the main body 110, such that the laser sensor 130 may track and/or detect a position of the main body 110. For example, the processing unit 122 executing the app may send the at least one command to the mobile device 10 to move a cursor in response to moving the main body 110. In other words, movement of the laser sensor 130 may correspond to movement of the cursor and/or another movement function on the mobile device 10.

Alternatively, the processing unit 122 executing the app may determine movement of the main body 110 corresponding to other functions on the mobile device 10, such as scrolling, zooming, clicking, tapping, using GPS, sending and/or reading texts, and/or running apps, etc.

The input button 140 may be disposed on at least a portion of the main body 110. The input button 140 may be used for entry of information. More specifically, the processing unit 122 executing the app may determine the input button 140 is an enter and/or an accept button, such that the mobile device 10 may receive the enter command in response to depressing the input button 140.

The volume button 150 may be disposed on at least a portion of the main body 110. The volume button 150 may increase a volume level in response to depressing a first end of the volume button 150. Conversely, the volume button 150 may decrease the volume level in response to depressing a second end of the volume button 150.

The speaker 160 may include a microphone, but is not limited thereto.

The speaker 160 may be disposed on at least a portion of the main body 110. The speaker 160 may receive at least one sound input therein and/or emit at least one sound output therefrom, such as at least one voice command of the user. More specifically, the speaker 160 may receive the at least one voice command equivalent to a command from the processing unit 122 based on input from the display unit 121 (e.g., a touch input) and/or the input button 140. For example, the speaker 160 may receive a scroll command, a cursor movement command, a zoom command, a click command, and/or a tap command, but is not limited thereto. In other words, the speaker 160 may facilitate operating the mobile device 10 without using hands of the user. Also, the speaker 160 may emit the at least one sound output to indicate a current position of the mobile device 10 and/or a last executed command of the mobile device 10. The volume button 150 may increase and/or decrease the volume level of the speaker 160.

Furthermore, the speaker 160 may emit the at least one sound from the exercise training regimen, such as reciting a name of the exercise, the type of movements, an amount of time remaining, etc.

The power button 170 may be disposed on at least a portion of the main body 110. The power button 170 may turn on the control unit 120, the laser sensor 130, the input button 140, the volume button 150, and/or the speaker 160 in response to depressing the power button 170 a first time. Conversely, the power button 170 may turn off the control unit 120, the laser sensor 130, the input button 140, the volume button 150, and/or the speaker 160 in response to depressing the power button 170 a second time.

The power source 180 may include a battery and a solar cell, but is not limited thereto.

The power source 180 may be disposed within at least a portion of the main body 110. The power source 180 may provide power to the control unit 120, the laser sensor 130, the input button 140, the volume button 150, the speaker 160, and/or the power button 170.

The pad assembly 190 may include a pad body 191, a magnet 192, a communication unit 193, and a pad power source 194, but is not limited thereto.

The pad body 191 may be removably connected to at least a portion of the main body 110. Also, the pad body 191 may be removably connected to a steering wheel, a planar surface (e.g., a desk, table), and/or worn on the user. The pad body 191 may have an adhesive (e.g., tape, glue), a cord, a wire, a string, a rope, and/or any other type of fastener, but it not limited thereto.

The magnet 192 may be disposed on at least a portion of the pad body 191. Moreover, the magnet 192 may connect the main body 110 to the pad body 191. Additionally, the pad body 191 may facilitate the laser sensor 130 tracking the position of the main body 110.

It is important to note that the laser sensor 130 may operate differently while the main body 110 is detached from the pad body 191, such as while being worn using the strap 111 and/or the buckle 112. For example, the main body 110 may be moved to move the cursor on the mobile device 10 without the laser sensor 130 tracking the position of the main body 110 across the pad body 191. The communication unit 123 may use GPS signaling to indicate to the processing unit 122 the position of the main body 110 with respect to a first position and a second position, such as waving the hands of the user.

The communication unit 193 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The communication unit 193 may be disposed within at least a portion of the pad body 191. The communication unit 193 may transmit the position of the laser sensor 130 to the mobile device 10, such that the communication unit 193 may operate as a backup for determining the position of the main body 110 moving across the pad body 191.

The pad power source 194 may include a battery and a solar cell, but is not limited thereto.

The pad power source 194 may be disposed within at least a portion of the main body 110. The pad power source 194 may provide power to the magnet 192 and/or the communication unit 193.

Therefore, the mobile device input device 100 may facilitate control of the mobile device 10 without requiring the hands of the user. Also, the mobile device input device 100 may allow the user to continue performing other tasks, such as driving, office work, and/or other tasks.

The present general inventive concept may include a mobile device input device 100 connected to a mobile device 10, the mobile device input device 100 including a main body 110 to be worn by a user, a control unit 120 running a program thereon and disposed within at least a portion of the main body 110 to at least one operation of the mobile device 10, and a laser sensor 130 disposed on at least a portion of the main body 110 to emit a laser beam away from a surface of the main body 110 to track a position of the main body 110.

The control unit 120 may receive input to create an exercise training regimen.

The control unit 120 may receive another input to create a timer for an exercise.

The control unit 120 may send at least one command to the mobile device 10 to move a cursor in response to moving the main body 110.

The control unit 120 may determine movement of the main body 110 that corresponds to other functions on the mobile device 10 that are at least one of scrolling, zooming, clicking, tapping, sending a text, reading the text, and running an application.

The mobile device input device 100 may further include an input button 140 disposed on at least a portion of the main body 110 to enter entry of information.

The mobile device input device 100 may further include a speaker 160 disposed on at least a portion of the main body 110 to receive at least one sound input therein and emit at least one sound output therefrom.

The mobile device input device 100 may further include a pad assembly 190 removably connected to at least a portion of the main body 110 to facilitate tracking of the laser sensor 130 over the pad assembly 190 in response to movement of the main body 110 over the pad assembly 190.

The control unit 120 may use GPS signaling to determine the position of the main body 110 instead of the laser sensor 130 while the main body 110 is detached from the pad assembly 190.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A mobile device input device connected to a mobile device, the mobile device input device comprising:
a main body to be worn by a user;
a control unit, comprising:
a display unit disposed on at least a portion of the main body to display at least one of a time and a date, and to receive an input thereon, and
a processing unit disposed within at least a portion of the main body running a program thereon to remotely control at least one operation of the mobile device; and
a laser sensor disposed within at least a portion of the display unit to emit a laser beam away through a surface of the display unit to track a position of the main body, such that the processing unit remotely moves a cursor on the mobile device corresponding to movement of the laser sensor.

2. The mobile device input device of claim 1, wherein the control unit receives an input to create an exercise training regimen.

3. The mobile device input device of claim 2, wherein the control unit receives another input to create a timer for an exercise.

4. The mobile device input device of claim 1, wherein the control unit sends at least one command to the mobile device to move the cursor in response to moving the main body.

5. The mobile device input device of claim 1, wherein the control unit determines movement of the main body that corresponds to other functions on the mobile device that are at least one of scrolling, zooming, clicking, tapping, sending a text, reading the text, and running an application.

6. The mobile device input device of claim 1, further comprising:
an input button disposed on at least a portion of the main body to enter entry of information.

7. The mobile device input device of claim 1, further comprising:
a speaker disposed on at least a portion of the main body to receive at least one sound input therein and emit at least one sound output therefrom.

8. The mobile device input device of claim 1, further comprising:
a pad assembly removably connected to at least a portion of the main body to facilitate tracking of the laser sensor over the pad assembly in response to movement of the main body over the pad assembly.

9. The mobile device input device of claim 8, wherein the control unit uses GPS signaling to determine the position of the main body instead of the laser sensor while the main body is detached from the pad assembly.

10. A mobile device input device connected to a mobile device, the mobile device input device comprising:
a main body to be worn by a user;
a control unit, comprising:
a display unit disposed on at least a portion of the main body to display at least one of a time and a date, and to receive an input thereon, and
a processing unit disposed within at least a portion of the main body running a program thereon to remotely control at least one operation of the mobile device;
a laser sensor disposed within at least a portion of the display unit to emit a laser beam away from a surface of the main body to track a position of the main body, such that the processing unit remotely moves a cursor on the mobile device corresponding to movement of the laser sensor; and
a speaker disposed on at least a portion of the main body to move a cursor of the mobile device in response to receiving at least one sound input.
